(19) United States
(12) Patent Application Publication
(10) Pub. No.: US 2005/0092411 A1
(43) Pub. Date: May 5, 2005

(54) Tire having expandable tread portion

(76) Inventor: John Michael O'Brien, Tualatin, OR (US)

Correspondence Address: SCHWABE, WILLIAMSON & WYATT, P.C.;PACWEST CENTER, SUITES 1600-1900, 1211 SW FIFTH AVENUE, PORTLAND, OR, 97204, US

(21) Appl. No.: 10/699,434

(22) Filed: Oct. 31, 2003

(51) Int. Cl. B60C 11/00; B60C 11/14; B60C 5/22; B29D 30/66; B29D 30/52

(52) U.S. Cl. 152/209.18; 156/114; 152/210; 152/339.1; 152/342.1

(57) ABSTRACT

A tire structure including a secondary chamber formed between a tire casing and road engaging tire tread. A first air passage provided from the tire interior to the secondary chamber and a second air passage through a side wall of the tire casing substantially adjacent a bead portion of the tire. An air line extends between the two air passages and is bonded to the interior side wall of the casing, and a valve unit associated with said second passage to provide controlled air inlet and relief to said chamber.

### FIELD OF THE INVENTION

This invention relates to a stud-bearing tire including mechanism for retracting and extending the studs, the mechanism being bonded to the tire during curing of the tire.

### BACKGROUND OF INVENTION

It is known that studs provided on tires provide increased traction when driving on snow and/or ice whereas they are non-beneficial and conversely detrimental to road maintenance when driving on bare roads (no ice or snow). Accordingly, systems have been developed for selective extension and retraction of the studs as illustrated by U.S. Pat. Nos. 6,244,666 and 6,386,252 as well as application U.S. Ser. No. 09/652,997, the disclosures of which are incorporated herein by reference.

The extension and retraction process of the system herein contemplated utilizes air pressure that expands and contracts an air pocket or pockets that is independent of the primary air chamber of the tire. Providing an air source and mechanism for achieving the inflation and deflation of the air pocket is an objective of the present invention.

### SUMMARY OF INVENTION

A preferred embodiment of the present invention is (a) the provision of a circular channel in the outer side of the tire tread; (b) the provision of a circular strip of tread material as an inset into the circular channel, the strip provided with protruding studs as desired; (c) an air line or tube to be sealed against the inner wall of the tire and which provides an air conduit between the position of the tread channel and a designated position at the side wall of the tire; and (d) a miniaturized unit having selected features such as a self-charging battery, air pump, air pressure sensor/transmitter and valve stem. The above is incorporated into a tire through the process of (a) partial curing and thereby partial forming of a tire including an exterior circular channel; (b) providing an air passage (insertion of a metal ferrule) through the bottom of the tread channel and into the tire interior; (c) placement of the strip of tread material in the circular channel; (d) securing the air line to the inner wall of the tire which air line extends from the air passage to the designated position; (e) providing a second air passage through the tire wall at the designated position; (f) subjecting the tire and assembly of components to a final curing of the tire, the circular strip being adhered through said curing to the side walls of the tread chamber, and (g) snap on connection of the unit between the air line and second ferrule.

The above combination and procedure results in the provision of a remote-controlled operation (as desired) whereby the miniature pump maintains a desired air pressure in the primary chamber of the tire; as desired, the valve of the mechanism is opened to convey air pressure from the primary chamber to the tread chamber formed under the strip which expands the strip out of the channel and into road contact; as desired, the valve of the mechanism is closed and the air from the tread chamber is conveyed back to the second passage and through the second passage to atmosphere. The invention will be more clearly understood and appreciated upon reference to the following detailed description and the drawings referred to therein.

### BRIEF DESCRIPTION OF DRAWINGS

FIG. 1 illustrates in perspective a tire including the present invention;

FIG. 2 is a cross-sectional view of the tire of FIG. 1 showing the studs in a retracted position;

FIG. 3 is a further cross-section of the tire of FIG. 1 showing the studs extended;

FIGS. 4, 5 and 5A illustrate the process of forming the tire of FIG. 1; and

FIGS. 6A and 6B illustrate a tread strip insert of the invention.

### DESCRIPTION

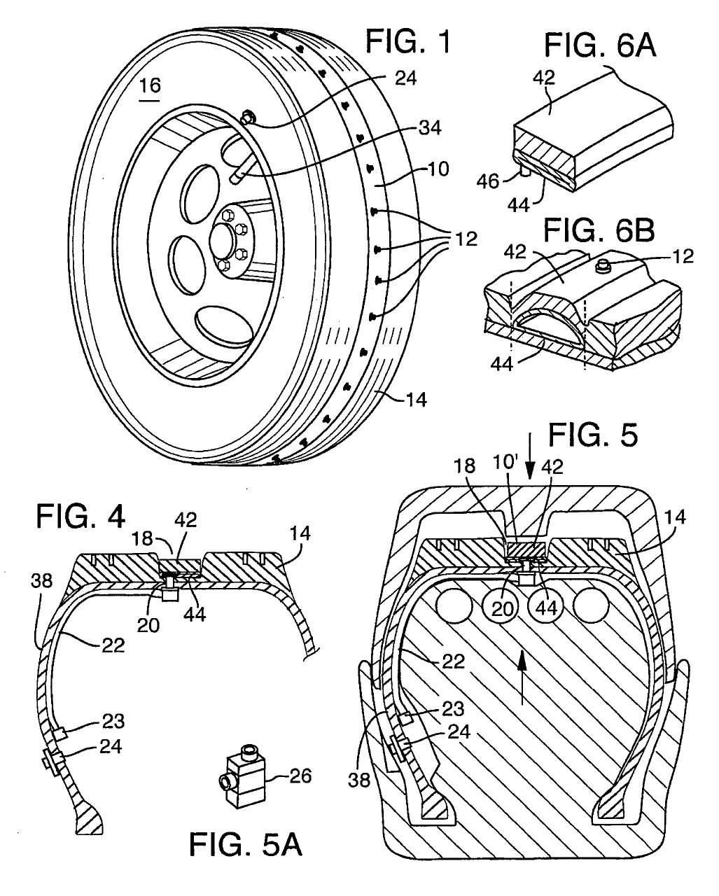

FIG. 1 illustrates a tire 16 for a vehicle including a circular strip 10 centered in the tire tread 14. The strip includes studs 12 as desired for enhanced gripping when traveling on ice or snow-laden roadways.

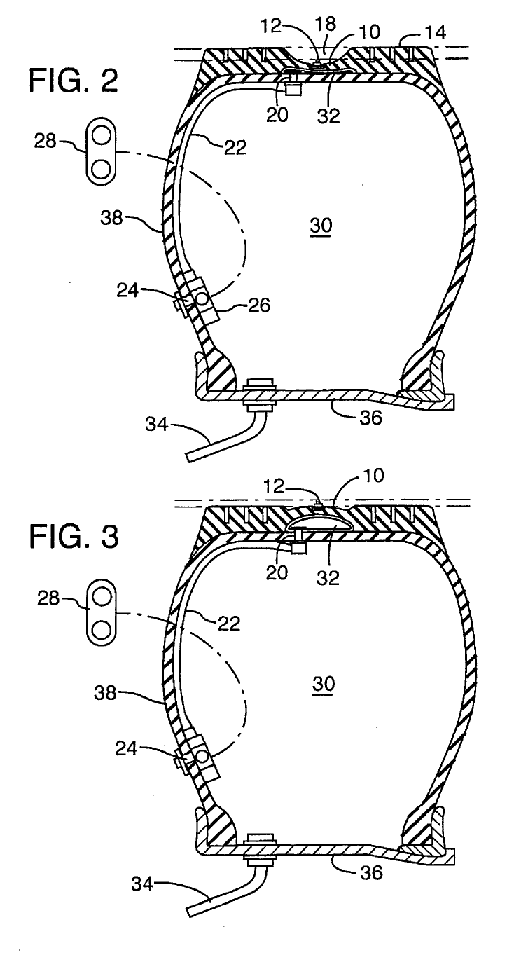

FIGS. 2 and 3 illustrate the mechanism by which the strip 10 with studs 12 is expanded and contracted from and into a channel 18 formed in the tread 14. A ferrule 20 from channel 18 (under strip 10) is projected through the tire casing where it is connected to an air line 22. Air line 22 is adhered to the inner wall of the tire casing 38 and extends along the side wall to a position where at the air line is connected to a second ferrule 24 which provides air passage through the wall to atmosphere.

Interposed between the ferrule 24 and air line 22 is a unit 26 that includes any of a variety of features such as a three way valve, self-charging battery, air pump and air pressure sensor/transmitter. Such devices are known and are commercially available, although not previously used in the capacity herein described.

Operation of the full contingency of components of the unit 26 enables both automatic and remote control of the mechanism e.g. by remote control device 28 mounted in the vehicle cab and operated by the vehicle's driver. In such an operation, the unit 26 automatically senses air pressure in the primary chamber 30 and controls the operation of the air pump of the unit to maintain a desired air pressure in primary chamber 30. When the driver encounters ice or snow, he will actuate the remote control device 28 which opens a valve of the unit 26 which in turn connects air line 22 to the primary air chamber 30. Air is then conveyed to secondary chamber 32 (FIG. 2) located under strip 10 to expand chamber 32 which extends strip 10 and stud 12 to the surface of tread 14 (FIG. 3) and thus into engagement with a roadway on which the tire is driven (presumably covered with snow or ice).

When the vehicle is no longer traveling in conditions of ice and or snow, the driver actuates the control device 28 to close the connection between chamber 30 and air line 22 and opens connection of the air line 22 to the passage through ferrule 24 and thereby to atmospheric pressure. The strip 10 at atmospheric pressure is retracted into the channel 18 as viewed in FIG. 2 and such retracts studs 12 to out-of-engagement relation with the roadway.

It will be observed that the illustrated structure includes a separate air inlet and valve 34 connected through tire rim 36 and into the primary air chamber 30. However, it is contemplated that the ferrule 24 can be extended and designed to fit the air hoses of typical exterior air pumps and further designed whereby the valve of the device 26, upon exposure to exterior air pressure through ferrule 24 will function to direct such exterior air pressure directly into the air chamber 30 and not to air line 22.

Having described the structure and the operation of the air-controlling mechanism, the following will describe the manner by which that mechanism is incorporated into a tire.

FIGS. 4 and 5 illustrate a two-step curing operation. In FIG. 4, a first step has been performed to generate a basic tire structure including a tire casing 38, a tread 14 secured to the casing 38 and channel 18 formed in the tread 14. Subsequent to the first step of curing and prior to a second step of curing, a release strip 44 (in the form of an expandable tube in this preferred embodiment and which will be further described hereafter) is placed in the channel 18. Ferrule 20 is forced through the casing 38 and into the channel 18 (under release strip 44). The second ferrule 24 is similarly applied to the casing wall and an air line 22 is placed at the inside of the casing between ferrules 20 and 24. A circular tread strip 42 overlays release strip 44 in channel 18 and the composite is subjected to the second step of curing as represented in FIG. 5.

Following the second cure process, the unit 26 is inserted between air line 22 and ferrule 24. The unit 26 is designed in conjunction with the ferrule 24 and end 23 of air line 22 to be snap fitted into place (the unit 26 being anticipated to not withstand the heat of the curing operation).

Further explanation of the release strip 44 and tread strip 42 is provided with reference to FIGS. 6A, 6B. A tread segment 42 is pre-bonded/cured to a thin wall tube 44, the tube 44 having a stem 46 that fits down through the ferrule 20 (FIG. 4) for passage of air to and from the chamber 32. FIG. 6A shows the tube 44 and tread strip 42 bonded together in a precuring operation and prior to bonding/curing thereof to the side walls of the tire channel 18. FIG. 6B shows the tube 44 following the final curing step and in the expanded, stud extended position.

It will be appreciated that there are numerous variations and modifications that can be made to the above disclosed embodiment without departing from the inventive concept as defined by the claims appended hereto. As previously explained, the unit 26 can be reduced to any or a combination of the features described i.e. self-charging battery, three way valve, air pump, air pressure sensor/transmitter. Conversely, in its simplest form, unit 26 can be eliminated and the air line 22 connected directly to ferrule 24. Ferrule 24 would function as a conventional air inlet valve whereby air could be pumped to line 22 when extension of the studs is desired, and the valve manually depressed to release the air from line 22 to atmosphere for stud retraction. Alternatively the unit 26 could function merely as a remote controlled valve i.e. actuated to connect chambers 32 and 30 and actuated to close that connection and connect chamber 32 to atmosphere. (Numerous cycles of stud extension-retraction can be achieved with very gradual loss of air pressure in the primary chamber 30 of the tire.).

1. A tire structure comprising:
a tire casing having a top and side walls terminating at a bead portion and defining a primary air chamber;
a tread bonded to the casing top and defining a road engaging tread surface, a channel formed in the tread surface and a secondary chamber formed under a tread portion at said channel, a first air passage through the casing and into the secondary chamber, a second air passage through the casing at a side wall position of the casing substantially adjacent the bead portion, and an air line bonded to the interior wall of the casing and extending from said first air passage to the second air passage; and
a valve unit in said second air passage controlling air into and air out of second air passage and accordingly through the air line and said first air passage to said second chamber.

2. A tire structure as defined in claim 1 wherein said valve unit includes multiple valve function including receiving air from the primary chamber for expanding the secondary chamber and releasing air from the secondary chamber to atmosphere, and further including remote control actuation.

3. A tire structure as defined in claim 2 wherein said valve unit includes an air pump and air pressure sensor/transmitter.

4. A system for tire stud extension and retraction which comprises:
forming a tire structure including a tire tread bonded to a tire casing having opposing bead portions for sealing the tire to a support rim, said tire tread provided with a circular channel formed in the tread;
placing a tread strip having studs in the circular channel,
forming a first air passage through the tire casing and into the circular channel under the tread strip;
forming a second air passage through a side wall of the tire casing substantially adjacent to a bead portion, and extending an air line between the air passages and providing the second air passage with a valve unit,
curing the tire structure resulting in a structure enabling the introduction and relief of air pressure through said valve unit and air line to said circular channel for extending and retracting the stud carrying tread strip.

5. A wheel comprising;
a tire mounted on a wheel rim and said tire and wheel rim cooperatively forming a wall defining an enclosed primary chamber for containing air under pressure.
said tire including an expandable-retractable tread position;
a secondary chamber under said expandable-retractable tread portion, and as expanded said tread portion projected into road engagement position, and as retracted said tread portion withdrawn into non road engagement position;
a valve within said primary chamber including a first stem portion in communication with ambient air, and further including a second stem portion in communication with the secondary air chamber, said valve being a three way valve including mechanism enabling selective connection as between a) ambient air outside the wheel and the secondary chamber, and b) air under pressure in the primary chamber and the secondary chamber.
